(19) United States
(12) Patent Application Publication
(10) Pub. No.: US 2014/0172511 A1
(43) Pub. Date: Jun. 19, 2014

(54) System and method for sales performance improvement by identifying isotonic architecture

(71) Applicant: HCL Technologies Limited, Chennai (IN)

(72) Inventors: Jeyavardhan Suram, Chennai (IN); Gopal Sridharan, Chennai (IN)

(73) Assignee: HCL Technologies Limited, Chennai (IN)

(21) Appl. No.: 14/029,130

(22) Filed: Sep. 17, 2013

(51) Int. Cl. G06Q 10/06

(52) U.S. Cl. CPC G06Q 10/0637
USPC 705/7.36

(57) ABSTRACT

Disclosed herein is a method and system for improving performance of a sales person by generating appropriate suggestions. When the sales person has to approach a client organization to do business, the system collects information related to the client organization and builds a people map. Information in the people map is processed to identify parameters such as power centre, power play and power centre in the client organization. Further, based on the identified power centre, power play and power centre information, suggestions are made so as to help the sales person to improve knowledge about the client organization and to strategize sales approach accordingly.

### TECHNICAL FIELD

The embodiments herein relate to sales methodology and, more particularly, to improve business by identifying power play, power shift and power center in an organization being approached for sales.

### BACKGROUND

Sales is an art which involves selling of products or services. Companies that manufacture products or which offers services requires clients to achieve success in business. A sales man/sales woman is a person who is supposed to approach clients and provide information related to product (s) to be sold. Clients may or may not agree for purchase depending on the way of interaction they have with the sales person.

A good sales person can convince the clients to purchase goods from the manufacturer. As we all know, probability of a person in need purchasing a product is more than that of a person having no interest purchasing the same product. So it is very important for the sales person to be aware of the person he/she is approaching. In other words, it is important for a sales person to approach the right client.

Various sales methodologies are used by each company so as to improve the seller's performance and on field behavior, which in turn fetch business and increase revenue of the company. However, all existing methodologies teach sales men to focus on decision makers in the buyer's organization. However, these methods are not efficient as they do not take into consideration, changes occurring within the organization. As a result of this, the sellers fail to approach buyers with proper preparations done. This reduces probability of getting business.

### SUMMARY

In view of the foregoing, an embodiment herein provides a method for improving performance of a sales person by generating suggestions. The method comprises collecting a plurality of information related to c client organization. Further, a people map is generated based on the collected information and by processing the generated people map, power centre, power shift and power play in the client organization are identified. Further, at least one suggestion is generated based on the identified power centre, power shift and power play in the client organization.

Embodiments further disclose a sales performance improvement system for improving performance of a sales person by generating suggestions. The system is configured for collecting a plurality of information related to a client organization using an Input/Output (I/O) interface. Further, using a map generating module, a people map is generated based on the collected information. Further, the system identifies a power centre, power shift and power play in the client organization by processing the generated people map using a processing engine and then, at least one suggestion is generated based on the identified power centre, power shift and power play in the client organization using the processing engine.

These and other aspects of the embodiments herein will be better appreciated and understood when considered in conjunction with the following description and the accompanying drawings.

### BRIEF DESCRIPTION OF THE FIGURES

The embodiments herein will be better understood from the following detailed description with reference to the drawings, in which:

FIG. 1 illustrates a block diagram of the sales performance improvement system, as disclosed in the embodiments herein;

FIG. 2 is a block diagram that shows various components of the sales performance improvement system, as disclosed in the embodiments herein;

FIG. 3 is a block diagram that shows various components of a processing engine, as disclosed in the embodiments herein;

FIG. 4 illustrates a flow diagram that shows various steps involved in the process of generating suggestions for business improvement using the sales performance improvement system, as disclosed in the embodiments herein;

FIG. 5 illustrates a flow diagram that shows various steps involved in the process of identifying power shifts, power plays and power centers in an organization using the sales performance improvement system, as disclosed in the embodiments herein;

FIG. 6 illustrates 3 dimensional structure of needs according to Isotonic architecture, as disclosed in the embodiments herein;

FIG. 7 illustrates types of needs being addressed by the isotonic architecture, as disclosed in the embodiments herein;

FIG. 8 illustrates the way demands are addressed by a seller using isotonic architecture, as disclosed in the embodiments herein;

FIG. 9 illustrates revenue potential created by each zone in the needs pyramid in the isotonic architecture, as disclosed in the embodiments herein;

FIGS. 10 and 11 illustrate power center, power plays and power shifts of an organization according to the isotonic architecture, as disclosed in the embodiments herein; and

FIGS. 12, 13 and 14 illustrate change in business revenue with different elements of the needs pyramid of the isotonic architecture, as disclosed in the embodiments herein.

### DETAILED DESCRIPTION OF EMBODIMENT

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

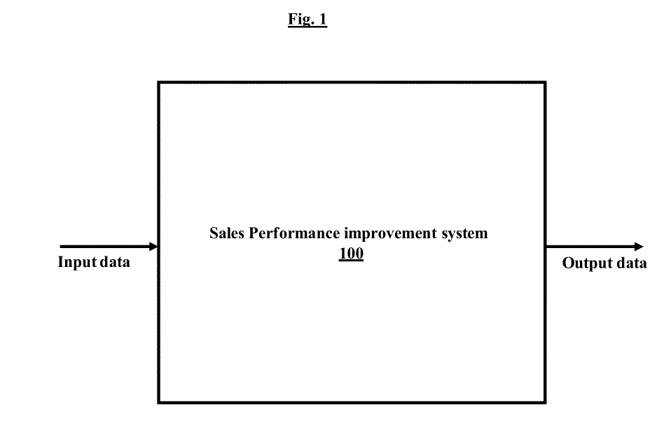

The embodiments herein disclose a method and system for sales performance improvement by using an isotonic architecture. Referring now to the drawings, and more particularly to FIGS. 1 through 14, where similar reference characters denote corresponding features consistently throughout the figures, there are shown embodiments.

FIG. 1 illustrates a block diagram of the sales performance improvement system, as disclosed in the embodiments herein. In a sales process, “need” is an important factor that decides success rate of a sales attempt. Chance of a person in need purchasing a product is more than that of a person in no need purchasing the product. The sales performance improvement system 100 projects need as a HOLISTIC NEED that forms a relation between value, demand, and revenue in a 3 dimensional form. A sales person can succeed in fetching a business if he/she has better knowledge about the client (individual/company) to be approached for the business. Depending on understanding of the sales person, the “Need” is classified into three different zones namely “Determined needs”, “Anticipated needs” and “Prophetic needs”. A sales person in “Determined need” state implies the person has minimal knowledge about the client which means success rate is less and margins are compromised. In this case, sale happens by chance.

Anticipated zone offers incremental value as compared to the determined needs by providing break through solutions. A sales person in this zone has better idea about interplay between technology and business. A sale in this zone is driven through intelligence built on information sourced from business. The anticipated zone ensures accelerated revenues, increase in bottom line and improved bid to win ratio.

In Prophetic zone, sales person is able to predict changes in market dynamics and discuss with a frame of reference to eco system changes. This is an elevated phase in relationship level and is advisory in nature. Further, character of discussion centers in futuristic revenues, technology streams, business model so on. Sale in this zone happens by Choice and is devoid of competition/budget/policy constraints. A sales person can be in a prophetic zone by having knowledge about power plays, power centers and power shifts in an organization to be approached (client) for business purpose.

Power center in an organization refers to highest official in the organization i.e. an official who has ability to influence and control anything that is of value to the organization. Power centers exhibit a tendency to effect a change in some way. Dependency among individuals is the most important concept in power centers. The degree of dependence of the individuals in power centers is a function of importance, scarcity of the resources controlled by the power centers.

Power play is a process that is beneficial to employees and unhealthy for organization and business. It is a result of an activity by a group of persons whose inability to effectively perform reduces productivity and performance. Further, power play is a behavior that others may perceive as self-serving tactics for personal gains at the expense of the organization. If the sales approach being implemented does not serve an understanding of power play early on in the sales process, then power play may have dangerous repercussions on the salesman & buying process and a price to pay.

Power shift refers to replacement of a higher official; say power centre, by a different person. Power shifts in bigger organizations are quite tough to notice/identify and has great impact on strategies of the organization. For example, when a power centre in an organization is replaced by another one, the new person may have significantly different vision and may implement new strategies accordingly. Power shift reshapes power boundaries and alters buying criteria and shifts loyalties. The reconfiguration of power happening due to power shift may either create opportunities or change fortunes. Power shifts may occur due to any of the following reasons: attrition of people/Acquisition of new businesses/Admiration of newer technologies, new players emerge in businesses causing a dynamic shift in power, financial crisis can alter power shifts, and cleavages among individuals in power centres refuse to disappear, and will evolve into a major axis for power shifts in organizations. With reshaping of power, choices of the organization also may change. A sales person has to be aware of these choices while approaching the organization for business purpose.

The sales performance improvement system 100 provides suggestions for sales person/user so as to help him/her move to the prophetic zone and increase business revenue. In a preferred embodiment, the sales performance improvement system 100 works based on principles of an isotonic architecture; wherein the isotonic architecture provides a practical approach to sellers and shapes their on field behaviors. Initially, the sales performance improvement system 100 fetches information such as total number of employees in the organization, percentage of employees known, name, designation, team structure and so on. The sales performance improvement system 100 initially generates a database called people map which comprises information on organizational structure and people in each stage/level of the organization. Further the sales performance improvement system 100 processes the data associated with the people map and identifies power centre, power shifts and power plays in the organization. Further, the sales performance improvement system 100 generates suggestions related to power centre, power shifts and power plays in the organization, responsible person/person to meet so as to improve chance of getting business, an ideal way to approach and discuss the business proposal and so on. Once the suggestions are generated, the user may provided with options to validate the output i.e. suggestions made, and if the output is not accurate or is not meeting the expectations of the sales person, the analysis may be redone which may generate different suggestions.

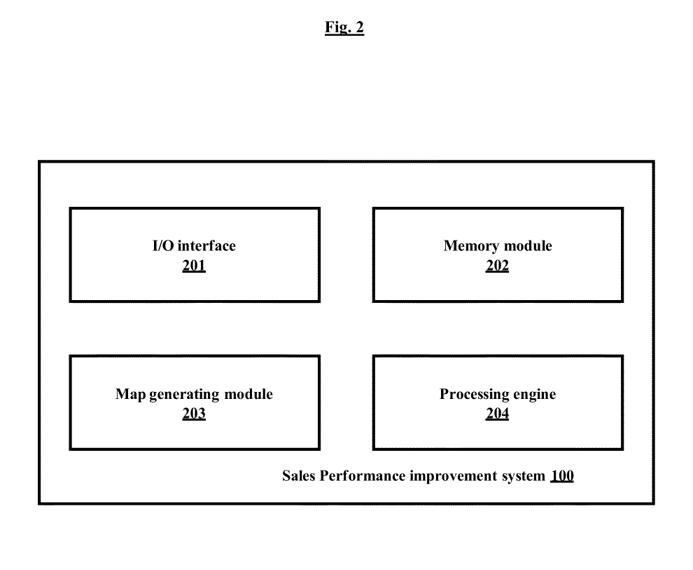

FIG. 2 is a block diagram that shows various components of the sales performance improvement system, as disclosed in the embodiments herein. The sales performance improvement system 100 comprises of an Input/Output (I/O) interface 201, a memory module 202, a map generating module 203, and a processing engine 204. The I/O interface 201 provides means for the sales performance improvement system 100 to connect to any external sources and collect required inputs. The I/O interface 201 may also provide means for the user to interact with the system so as to manually provide any inputs required and/or to view and validate results/suggestions. The I/O interface 201 may provide suitable user interface in the form of a keyboard, touch screen, touch pad, display screen, printable media and so on for the communication.

The memory module 202 may be used to store information collected as inputs. Further, the people map (s) generated using the fetched information also is stored in the memory module 202. Further, suggestions generated by the sales performance improvement system 100 also are stored in the memory module 202. In an embodiment, the memory module 202 may store the data in associated internal storage devices. In another embodiment, the memory module 202 may store data in cloud based storage or any such external storage means.

The map generating module 203 is used to process input data and generate a people map. The people map comprises information on organizational structure with name, designation of people and internal team structure. The people map is unique for each organization and depends on the inputs being provided to the map generating module 203.

The processing engine 204 fetches and processes the people map generated by the map generating module 203 and identifies power center, power plays and power shifts in the organization being analyzed. The processing engine 204 may further generate suggestions related to methodology/strategies to be adopted so as to help the sales person improve chance/probability of sale.

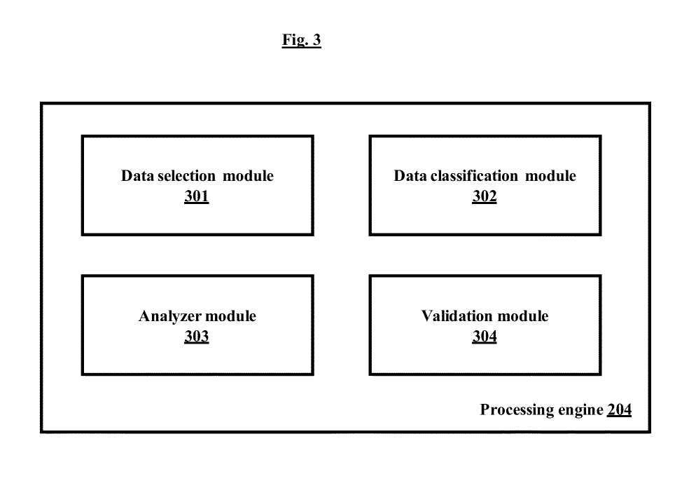

FIG. 3 is a block diagram that shows various components of a processing engine, as disclosed in the embodiments herein. The processing engine 204 further comprises of a data selection module 301, a data classification module 302, an analyzer module 303, and a validation module 304. The input data may comprise of useful data as well as less significant data. Only the useful data is to be processed so as to identify the power shifts, power centers and power center. The selection module 301 is used to identify and extract relevant data from the received input data. The selection module 301 may use a suitable data selection algorithm so as to identify and extract relevant data.

The extracted data is to be arranged into groups and classes depending on resemblance and similarities. This process helps in data condensation which in turn helps to identify power centers. The data classification module 302 is used to arrange the extracted data into groups and classes. Further, the analyzer module 303 analyzes the data and identifies power play, power shift and power center in the organization. Analyzer module 303 also generates suggestions related to power centre, power shifts and power plays in the organization, responsible person/person to meet so as to improve chance of getting business, an ideal way to approach and discuss the business proposal and so on. Further, the validation module 304 validates suggestions and other outputs of the analyzer module 303. In an embodiment, the validation module 304 may automatically validate the data based on set preferences. In another embodiment, the validation module 304 may require dynamically fetched user suggestions so as to validate the data.

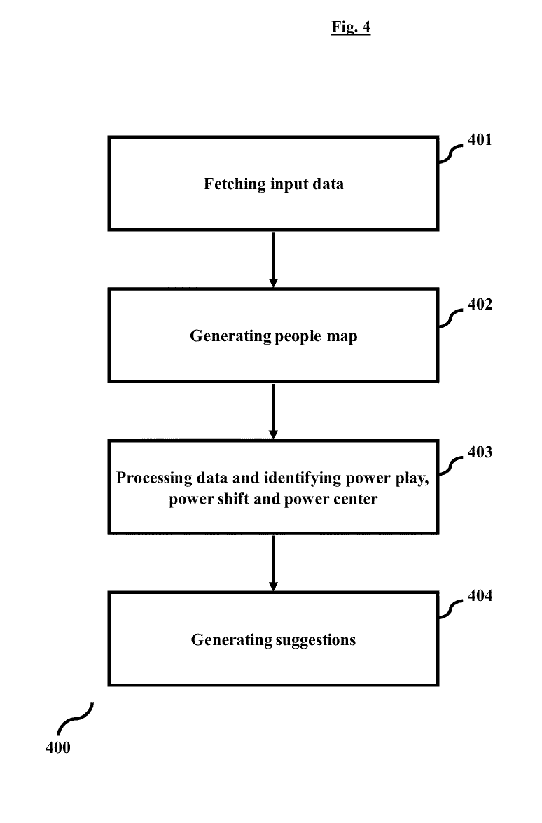

FIG. 4 illustrates a flow diagram that shows various steps involved in the process of generating suggestions for business improvement using the sales performance improvement system, as disclosed in the embodiments herein. A sales person who has knowledge about power center, power play and power shift in an organization has better chance of getting a sale from that organization. The sales performance improvement system 100 is used to understand power center, power play and power shift in any organization along with suggestions related to methodology to be adopted so as to improve probability of getting a sales confirmation from the organization that the sales person is approaching. Inputs to the sales performance improvement system 100 are total number of employees in the organization, percentage of employees known, name, designation, team structure, information on division of the organization where a sales proposal has to be initiated, information related to other divisions/departments in the organization if any, sales person's knowledge about people working in different levels of different divisions/departments and so on. The sales performance improvement system 100 fetches (401) the inputs and generates (402) a database called people map which comprises information on organizational structure and people in each stage/level of the organization. Further the sales performance improvement system 100 processes (403) the data associated with the people map and identifies power centre, power shifts and power plays in the organization. Further, the sales performance improvement system 100 generates (404) suggestions related to power centre, power shifts and power plays in the organization, responsible person or person to meet so as to improve chance of getting business, an ideal way to approach and discuss the business proposal and so on. Once the suggestions are generated, the user may provided with options to validate the output i.e. suggestions made, and if the output is not accurate or is not meeting the expectations of the sales person, the analysis may be redone which may generate different suggestions. The various actions in method 400 may be performed in the order presented, in a different order or simultaneously. Further, in some embodiments, some actions listed in FIG. 4 may be omitted.

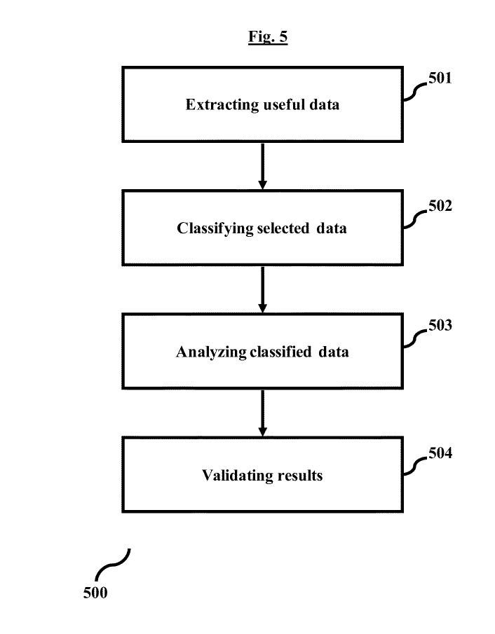

FIG. 5 illustrates a flow diagram that shows various steps involved in the process of identifying power shifts, power plays and power centers in an organization using the sales performance improvement system, as disclosed in the embodiments herein. The input data may comprise of useful data as well as less significant data. Only the useful data is to be processed so as to identify the power shifts, power centers and power center. Initially, useful/relevant data is identified and extracted (501) from the received input data using the selection module 301. In an embodiment, the data selection module 301 identifies useful data from the input data based on at least one of a plurality of pre-configured criteria.

The extracted data is to be arranged into groups and classes depending on resemblance and similarities. This process helps in data condensation which in turn helps to identify power centers. The data classification module 302 is used to classify (502) i.e. arrange the extracted data into groups and classes. Further, the data is analyzed (503) using the analyzer module 303 to identify power play, power shift and power center in the organization. The analysis process involves the analyzer module 303 comparing the people map generated for the organization against a pre-modeled organizational structure. In an embodiment, the pre-modeled organizational structure may be specific to each organization and may be stored in the memory module 202. For example, by comparing the people map against the pre-modeled organizational structure, the analyzer module 303 checks which position/person in the people map matches highest level/position in the pre-modeled organizational structure and once a match is obtained, it is displayed as power center of the organization. Similarly, based on the comparison, the analyzer module 303 identifies people who are in similar designations and who possess similar power in the organization and decides power play in the organization. Further, the analyzer module 303 checks whether the power center or any other higher officials of the organization has changed by comparing latest people map and a previous people map. If the highest official has changed, then the analyzer module 303 outputs information related to power shift in the organization. The analyzer module 303 also generates suggestions related to power centre, power shifts and power plays in the organization, responsible person/person to meet so as to improve chance of getting business, an ideal way to approach and discuss the business proposal and so on.

The generated suggestions and other outputs of the analyzer module are then validated (504) using the validation module 304 so as to ensure accuracy of the process and data. In an embodiment, the validation module 304 may automatically validate the data based on set preferences. In another embodiment, the validation module 304 may require dynamically fetched user suggestions so as to validate the data. The various actions in method 500 may be performed in the order presented, in a different order or simultaneously. Further, in some embodiments, some actions listed in FIG. 5 may be omitted.

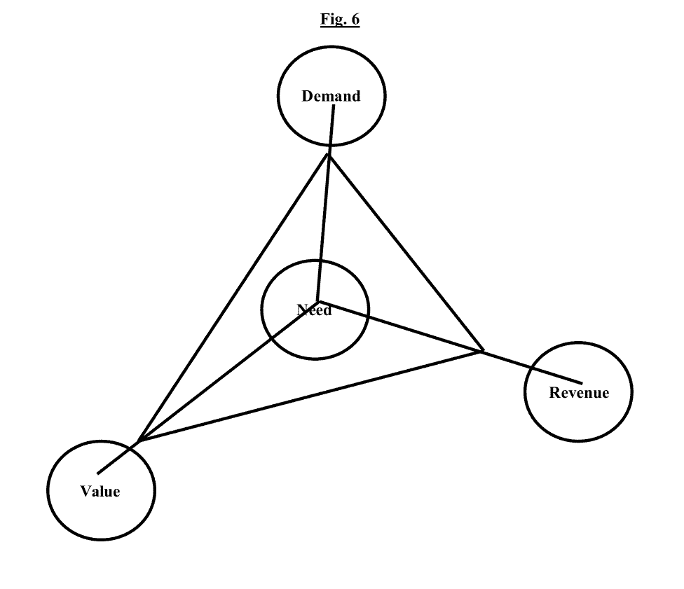

FIG. 6 illustrates 3-dimensional structure of needs according to isotonic architecture, as disclosed in the embodiments herein. The isotonic architecture represents “Need” as a 3 dimensional element. According to the 3 dimensional architecture, “Need” comprises of Demand, Value and Revenue. This is depicted in FIG. 6. Demand may refer to requirement of a client (an individual/organization). When a client has requirements, probability of occurrence of a sale is more. Further, when value of a product and/or service in offer is more, probability of sales approval is more. Further, with increase in demand and value, revenue of the organization increases.

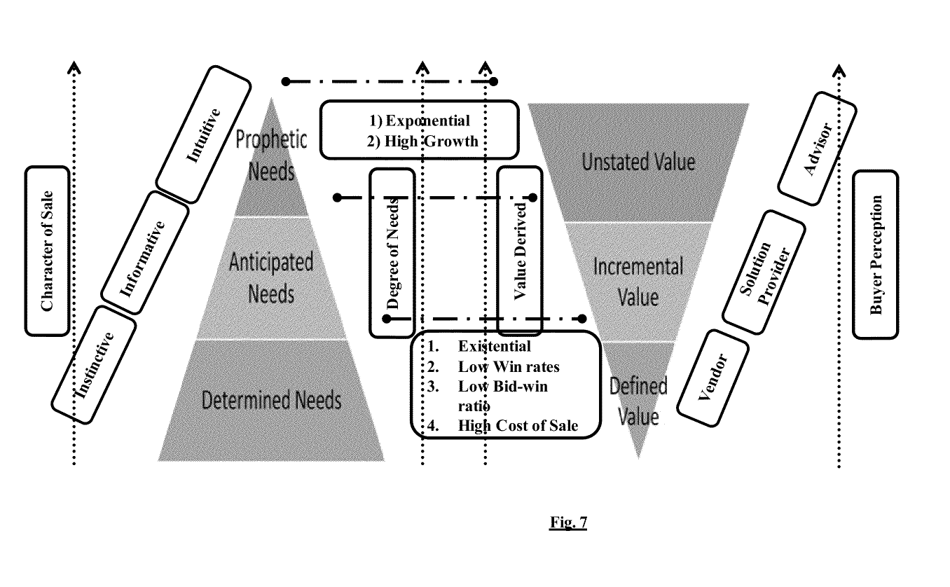

FIG. 7 illustrates types of needs being addressed by the isotonic architecture, as disclosed in the embodiments herein. A talented sales person is always an asset to the organization and can help increase revenue of the organization by fetching more business. A sales person having more knowledge about his client can strategize his approach in an efficient manner to convince the clients and to fetch business. Depending on level of knowledge of the sales person, he is classified under any of a determined needs, anticipated needs, or prophetic needs in the needs pyramid as depicted in FIG. 7. A sales person in determined need zone has minimal knowledge about his client. In this zone, discussions related to prize and operational excellence happen and a sale happens by chance as the sales person/seller is often very late in sales circle. Further, while dealing with a seller in the determined needs zone, the buyer may probably be resistive and revalidating price. As a result, deals made by a seller in the determined needs zone offers low win rates, low bid to win ratio and high cost of sale. A seller in the determined needs zone appears to be a vendor to the buyer.

Anticipated zone offers incremental value as compared to the determined needs by providing break through solutions. A sales person in this zone has better idea about interplay between technology and business. A sale in this zone is driven through intelligence built on information sourced from business. The anticipated zone ensures accelerated revenues, increase in bottom line and improved bid to win ratio. A seller in this zone appears to be a solution provider to the buyer.

In Prophetic zone, sales person is able to predict changes in market dynamics and discuss with a frame of reference to eco system changes. This is an elevated phase in relationship level and is advisory in nature. Further, character of discussion centers in futuristic revenues, technology streams, business model so on. Sale in this zone happens by Choice and is devoid of competition/budget/policy constraints. A sales person can be in a prophetic zone by having knowledge about power plays, power centers and power shifts in an organization to be approached (client) for business purpose. A seller in this zone appears to be an advisor to the buyer.

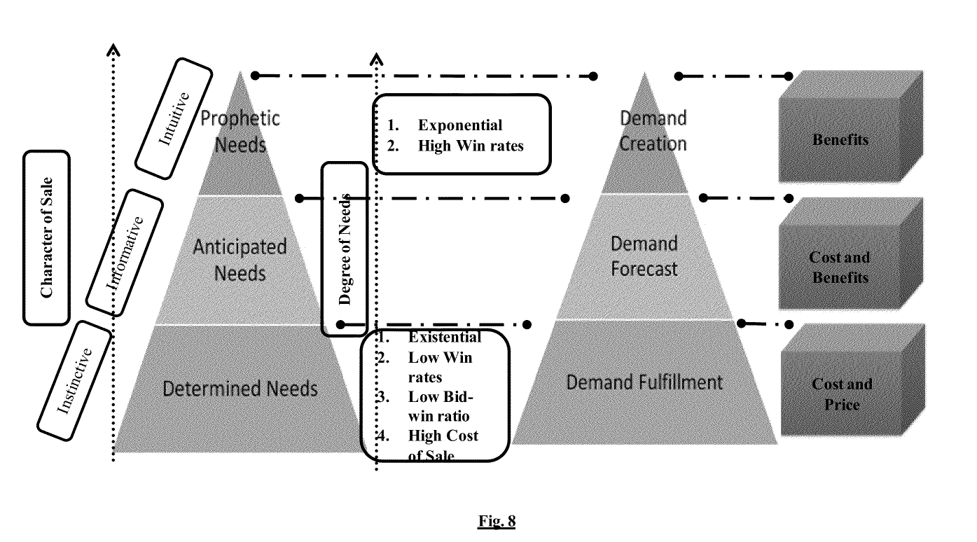

FIG. 8 illustrates the way demands are addressed by a seller using isotonic architecture, as disclosed in the embodiments herein. In a determined need zone, the seller addresses demands of the clients and in this zone; discussions between the seller and the client are cost driven. In the anticipated need zone, the seller can anticipate demand and discussion between the seller and the clients are about costs and benefits. In the prophetic need zone, the seller can create demand and discussions between the seller and the clients are about business betterment, competitive advantage to client, and business worth. As a result, deals in the prophetic zone offers high win rates and exponential increase in revenue from sales.

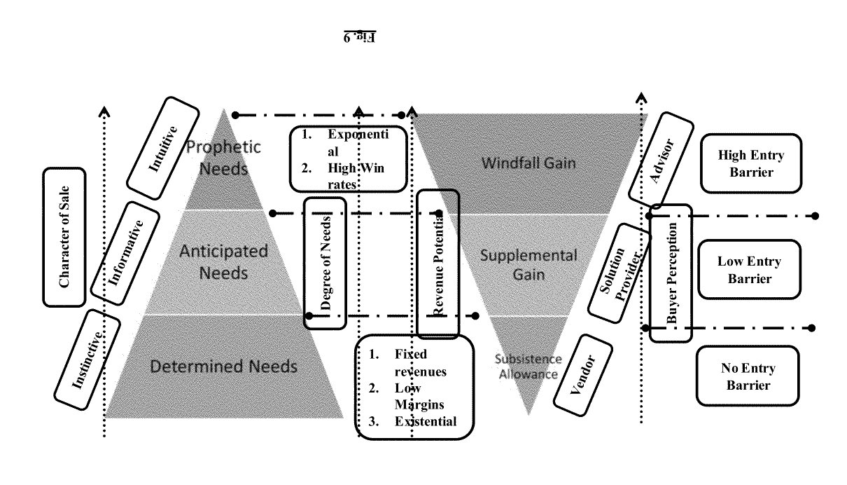

FIG. 9 illustrates revenue potential created by each zone in the needs pyramid in the isotonic architecture, as disclosed in the embodiments herein. In the determined zone, seller tends to play within an allocated budget; which in turn limits revenue potential. In this zone, probability to win an opportunity is cost driven with zero differentiation and hence, revenue derived from determined need zone is minimal and demonstrates an instinct for survival.

The anticipated needs zone creates a competitive advantage. It helps address unidentified needs of a customer. The solutions are highly tactical in nature. The sustainability factor, by focusing on anticipated need is low. Moderate barriers can allow competition to quickly scale up. The differentiating factors are few. Organizations have to be nimble enough to capitalize on the tactical advantage gained and should elevate to Intuit selling. The margins in this case, are better as compared to that in the determined needs zone. Revenue share increases, however sustainability of revenues largely remains on the capitalization of tactical advantage gained.

Prophetic needs zone provides maximum revenues. Operating in this zone creates the highest entry barriers. The deals are influenced by business acumen and profitable business models. Prophetic needs offer sustainable business benefits and not constrained by budget. Deals created in this space are influenced by CEOs and address strategy and vision goals. Sellers operating in this zone are driven by the desire for self-fulfillment and problem-centering.

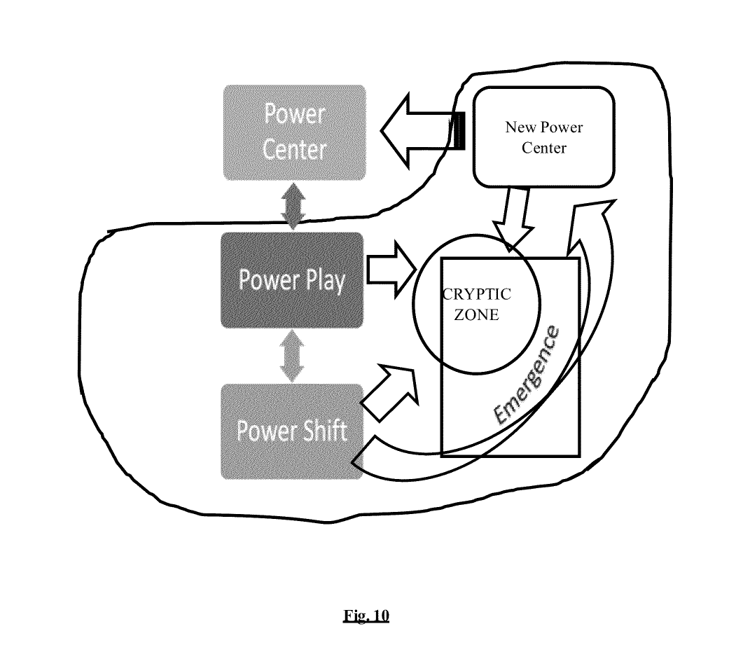

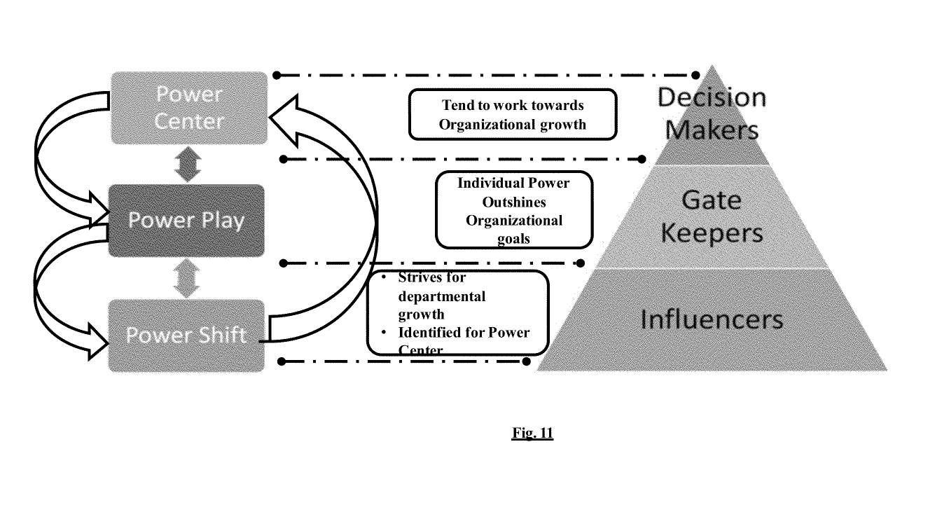

FIGS. 10 and 11 illustrate power center, power plays and power shifts of an organization according to the isotonic architecture, as disclosed in the embodiments herein. As per the isotonic architecture, so as to increase revenue of an organization to the maximum level, the sales person/seller has to reach the prophetic needs zone. The seller can reach this level by having extensive knowledge about power center, power plays and power shifts in the organization to be approached to fetch business. This is depicted in FIG. 10. Power center in an organization refers to highest official in the organization i.e. an official who has ability to influence and control anything that is of value to the organization. Power centers exhibit a tendency to effect a change in some way. Dependency among individuals is the most important concept in power centers. The degree of dependence of the individuals in power centers is a function of importance, scarcity of the resources controlled by the power centers.

Power play is a process that is beneficial to employees and unhealthy for organization and business. It is a result of an activity by a group of persons whose inability to effectively perform reduces productivity and performance. Further, power play is a behavior that others may perceive as self-serving tactics for personal gains at the expense of the organization. If the sales approach being implemented does not serve an understanding of power play early on in the sales process, then power play may have dangerous repercussions on the salesman & buying process and a price to pay.

Power shift refers to replacement of a higher official; say power centre, by a different person. Power shifts in bigger organizations are quite tough to notice/identify and has great impact on strategies of the organization. For example, when a power centre in an organization is replaced by another one, the new person may have significantly different vision and may implement new strategies accordingly. Power shift reshapes power boundaries and alters buying criteria and shifts loyalties. The reconfiguration of power happening due to power shift may either create opportunities or change fortunes. Power shifts may occur due to any of the following reasons: attrition of people/Acquisition of new businesses/Admiration of newer technologies, new players emerge in businesses causing a dynamic shift in power, financial crisis can alter power shifts, and cleavages among individuals in power centers refuse to disappear, and will evolve into a major axis for power shifts in organizations. With reshaping of power, choices of the organization also may change. A sales person has to be aware of these choices while approaching the organization for business purpose.

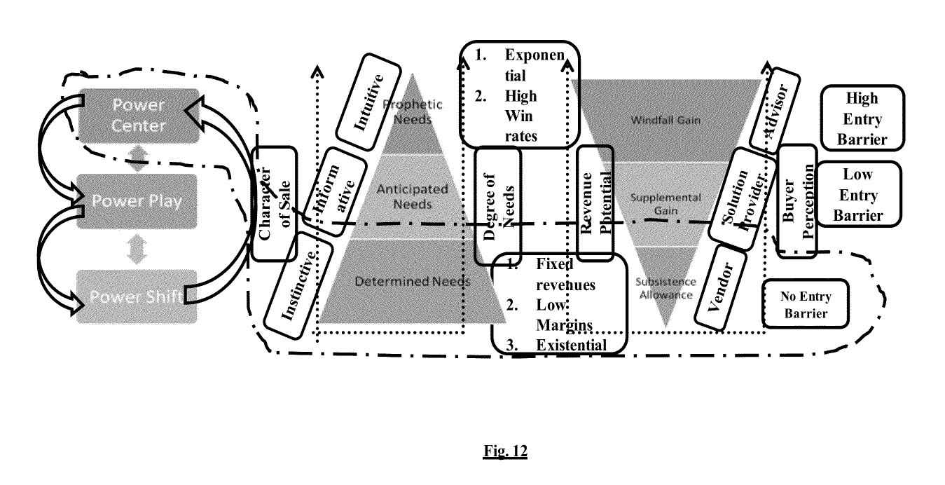

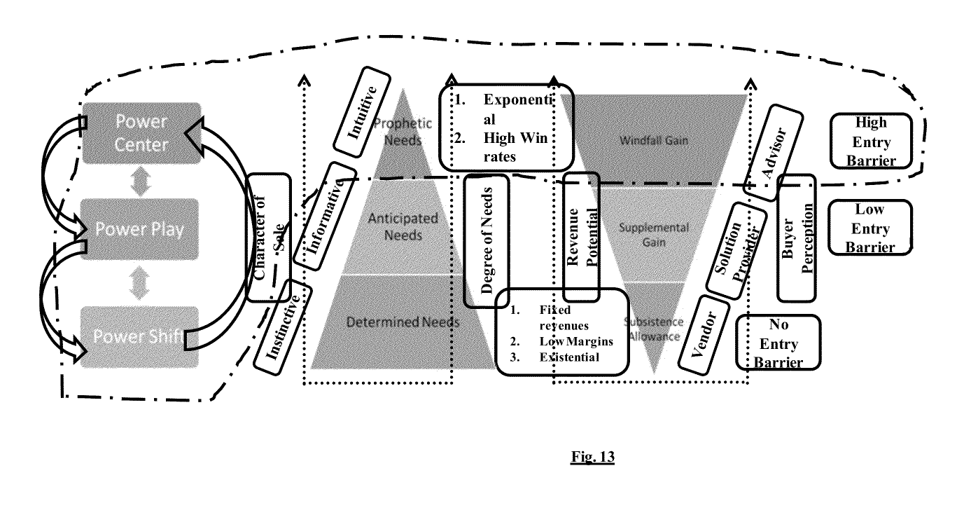

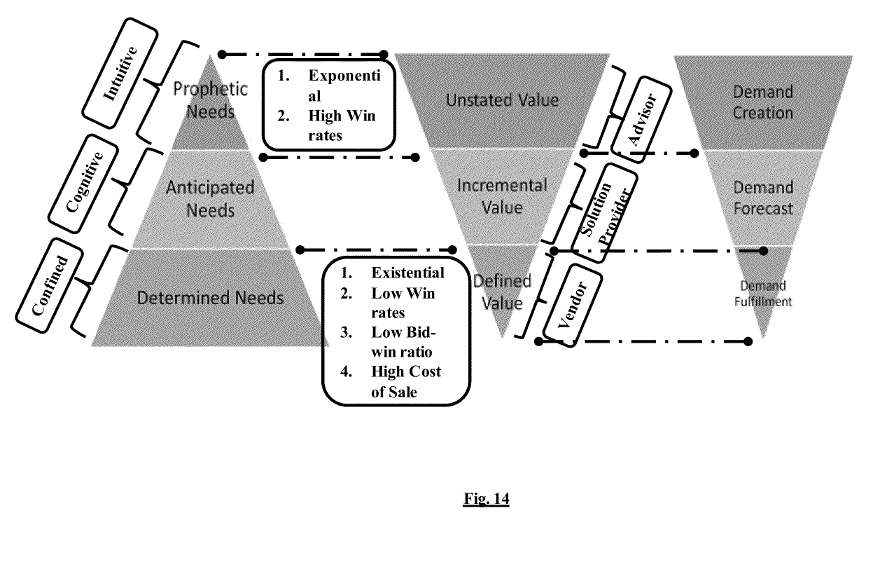

FIGS. 12, 13 and 14 illustrate change in business revenue with different elements of the needs pyramid of the isotonic architecture, as disclosed in the embodiments herein. A seller has minimal knowledge about the client organization when he is in the determined needs zone. This is depicted in FIG. 12. In this case, the seller has knowledge only about power center of the organization and not about power plays and power shifts. As a result, the revenue is less or is fixed and the business reaches only a subsistence allowance level. When a seller is in the anticipated needs, he has more knowledge about the client's organization. This is depicted in FIG. 13. As depicted in the FIG. 13, the seller has knowledge about power center and power plays in the client organization. This results in improved performance of the seller and the organization achieves supplemental gain. Sellers who concentrate on all three aspects (i.e. power center, power play and power shifts) reaches prophetic needs zone as depicted in FIG. 14. In the prophetic zone, organizations can achieve windfall revenue level which assures steep growth in revenue of the organization.

The embodiments disclosed herein can be implemented through at least one software program running on at least one hardware device and performing network management functions to control the network elements. The network elements shown in FIG. 2 include blocks which can be at least one of a hardware device, or a combination of hardware device and software module.

The embodiment disclosed herein specifies a system for sales performance improvement. The mechanism allows sales performance improvement in an organization, providing a system thereof. Therefore, it is understood that the scope of the protection is extended to such a program and in addition to a computer readable means having a message therein, such computer readable storage means contain program code means for implementation of one or more steps of the method, when the program runs on a server or mobile device or any suitable programmable device. The method is implemented in a preferred embodiment through or together with a software program written in e.g. Very high speed integrated circuit Hardware Description Language (VHDL) another programming language, or implemented by one or more VHDL or several software modules being executed on at least one hardware device. The hardware device can be any kind of device which can be programmed including e.g. any kind of computer like a server or a personal computer, or the like, or any combination thereof, e.g. one processor and two FPGAs. The device may also include means which could be e.g. hardware means like e.g. an ASIC, or a combination of hardware and software means, e.g. an ASIC and an FPGA, or at least one microprocessor and at least one memory with software modules located therein. Thus, the means are at least one hardware means and/or at least one software means. The method embodiments described herein could be implemented in pure hardware or partly in hardware and partly in software. The device may also include only software means. Alternatively, the embodiment may be implemented on different hardware devices, e.g. using a plurality of CPUs.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the claims as described herein.

1. A method for improving performance of a sales person by generating suggestions, said method comprises:
collecting a plurality of information related to a client organization;
generating a people map based on said collected information;
identifying a power centre, power shift and power play in said client organization by processing said generated people map; and
generating at least one suggestion based on said identified power centre, power shift and power play in said client organization.

2. The method as in claim 1, wherein said processing the people map to identify power centre, power play and power shift further comprises:
extracting useful data from said people map;
classifying said extracted useful data;
identifying said power centre, power play and power shift by analyzing said classified data; and
validating said identified power centre, power play and power shift.

3. The method as in claim 2, wherein said useful data is extracted from said people map based on at least one of a plurality of pre-configured criteria.

4. The method as in claim 2, wherein classifying said extracted useful data further comprises of arranging said useful data to at least one of a plurality of groups and classes.

5. The method as in claim 2, wherein analyzing said classified data further comprises comparing said classified data with a pre-modeled organizational structure.

6. The method as in claim 2, wherein said identified power centre, power play and power shift are validated automatically based on at least one of a plurality of set preferences.

7. A sales performance improvement system for improving performance of a sales person by generating suggestions, said system configured for:
collecting a plurality of information related to a client organization using an Input/Output (I/O) interface;
generating a people map based on said collected information using a map generating module;
identifying a power centre, power shift and power play in said client organization by processing said generated people map using a processing engine; and
generating at least one suggestion based on said identified power centre, power shift and power play in said client organization using said processing engine.

8. The sales performance improvement system as in claim 7, wherein said processing engine is further configured to process said people map to identify said power centre, power play and power shift by:
extracting useful data from said people map using a data selection module;
classifying said extracted useful data using a data classification module;
identifying said power centre, power play and power shift by analyzing said classified data using an analyzer module; and
validating said identified power centre, power play and power shift using a validation module.

9. The data selection module as in claim 8 is further configured to extract said useful data from said people map based on at least one of a plurality of pre-configured criteria.

10. The data classification module as in claim 8 is further configured to classify said extracted useful data by arranging said useful data to at least one of a plurality of groups and classes.

11. The analyzer module as in claim 8 is further configured to analyze said classified data by comparing said classified data with a pre-modeled organizational structure.

12. The analyzer module as in claim 8 is further configured to automatically validate said identified power centre, power play and power shift based on at least one of a plurality of set preferences.
